(19) United States
(12) Patent Application Publication
(10) Pub. No.: US 2025/0092732 A1
(43) Pub. Date: Mar. 20, 2025

(54) VEHICULAR SLIDING DOOR OPENING AND CLOSING APPARATUS

(71) Applicants: Hyundai Motor Company, Seoul (KR); Kia Corporation, Seoul (KR); Korea University Research and Business Foundation, Seoul (KR)

(72) Inventors: Kyoung-Taek Kwak, Yongin-si (KR); Jae-Seung Lee, Hwaseong-si (KR); Soo-Bok Kim, Incheon (KR); Gook-Hyun Jeon, Seoul (KR); Jae-Kyung Shim, Seoul (KR); Woon-Ryong Kim, Seoul (KR); Min-Seok Jo, Hwaseong-si (KR)

(21) Appl. No.: 18/627,613

(22) Filed: Apr. 5, 2024

(30) Foreign Application Priority Data
Sep. 19, 2023 (KR) 10-2023-0124744

(51) Int. Cl. E05F 15/655; E05F 15/649; E05F 15/652

(52) U.S. Cl. CPC E05F 15/655; E05F 15/649; E05F 15/652; E05Y 2201/624; E05Y 2201/696; E05Y 2900/531

(57) ABSTRACT

An embodiment opening and closing apparatus of a sliding door of a vehicle includes a carrier slidably installed along a lengthwise direction of the vehicle, a pair of links rotatably installed on the carrier and spaced apart from each other, wherein a first end portion of the pair of links is hinge-connected to the sliding door of the vehicle, and a popping-out device configured to pop the sliding door out of a vehicle body of the vehicle by rotating the pair of links during an initial stage of an opening operation of the sliding door.

### CROSS-REFERENCE TO RELATED APPLICATIONS

This application claims the benefit of Korean Patent Application No. 10-2023-0124744, filed on Sep. 19, 2023, which application is hereby incorporated herein by reference in its entirety.

### TECHNICAL FIELD

The present disclosure relates to a vehicular sliding door opening and closing apparatus.

### BACKGROUND

A door is installed on one side of a vehicle to allow an occupant to enter and exit a compartment of the vehicle or to load and unload luggage onto and from the vehicle.

For example, a sliding door, which is configured to slide along a lengthwise direction of the vehicle and opens and closes a lateral side of the vehicle, is installed on the lateral side of the vehicle.

The sliding door in a closed state is popped out over a predetermined distance in a widthwise direction of the vehicle, and then is slid, for opening, along the lengthwise direction of the vehicle. To close the sliding door, the sliding door is operated in a reverse order.

In a related art, a center rail for guiding a sliding operation of the sliding door is installed on the lateral side of the vehicle, and a roller that is moved along the center rail is installed on the sliding door. The sliding door needs to be fully popped out in a widthwise direction of the vehicle enough to provide a space where the center rail and the rail may operate and to prevent an internal surface of the sliding door from interfering with an external surface of the vehicle.

However, when a distance over which the sliding door is popped out from the external surface of the vehicle is increased, a problem arises in that an occupant waiting to enter the vehicle or a person staying in the vicinity of the vehicle may be injured due to a bump by the sliding door being popped out.

In addition, the center rail installed on the lateral side of the vehicle is exposed to the outside of the vehicle when the sliding door is closed, which deteriorates an exterior appearance of the vehicle.

### SUMMARY

The present disclosure relates to a vehicular sliding door opening and closing apparatus. Particular embodiments relate to a vehicular sliding door opening and closing apparatus capable of opening and closing a sliding door, on a lateral side of a vehicle, that is intended to be opened and closed in a lengthwise direction of the vehicle.

An embodiment of the present disclosure provides a vehicular sliding door opening and closing apparatus capable of stably opening and closing a sliding door without using a center rail and of minimizing a distance over which the sliding door protrudes from a lateral side of the vehicle during an operation of opening and closing the sliding door.

According to an embodiment of the present disclosure, there is provided a vehicular sliding door opening and closing apparatus including a carrier slidably installed along a lengthwise direction of a vehicle, a pair of links rotatably installed on the carrier in such a manner as to be spaced apart from each other, one end portion of the pair of links being hinge-connected to a sliding door of the vehicle, and a popping-out unit for popping the sliding door out of a vehicular body of the vehicle by rotating the pair of links during an initial stage of an opening operation of the sliding door.

In the vehicular sliding door opening and closing apparatus, the popping-out unit may include a roller installed on the other end portion of the pair of links and a moving guide rotating the pair of links during the initial stage of opening of the sliding door by guiding a tracking path for the roller.

In the vehicular sliding door opening and closing apparatus, the moving guide may include a first popping-out section formed in a widthwise direction of the vehicle, a sliding section formed in the lengthwise direction of the vehicle, and a second popping-out section formed in a circular arc shape and connecting an external end of the first popping-out section and one end of the sliding section.

In the vehicular sliding door opening and closing apparatus, when the pair of links is moved along the carrier, the pair of rollers may rotate the pair of links while being moved in the first popping-out section and the second popping-out section, thereby popping out the sliding door.

In the vehicular sliding door opening and closing apparatus, the pair of rollers may be rotated more when the roller is moved in the first popping-out section than when moved in the second popping-out section.

In the vehicular sliding door opening and closing apparatus, when the roller is moved in the sliding section, the pair of links may not be further rotated in order for the sliding door to maintain a popped-out state.

In the vehicular sliding door opening and closing apparatus, the pair of links may include a first link and a second link that are arranged to be spaced apart along the lengthwise direction of the vehicle, and the roller may be installed on the other end portion of the first link.

In the vehicular sliding door opening and closing apparatus, in a state where the sliding door is closed, the roller may be positioned more toward the front, in a sliding direction, of the sliding door, than a first link rotational axis of the first link.

In the vehicular sliding door opening and closing apparatus, the moving guide may be formed to have a concave cross section, and thus the roller may be positioned and moved inside the moving guide.

The vehicular sliding door opening and closing apparatus may further include a guide rail installed on the vehicular body along the lengthwise direction of the vehicle and a slider slidably installed on the guide rail, the carrier being mounted on the slider.

In the vehicular sliding door opening and closing apparatus, a plurality of the sliders may be provided and may be mounted on the carrier in such a manner as to be spaced apart from each other.

In the vehicular sliding door opening and closing apparatus, a door bracket may be installed on the sliding door and one end portion of each of the pair of links may be hinge-connected to the door bracket.

In the vehicular sliding door opening and closing apparatus, the carrier, the pair of links, and the door bracket may form a parallelogramic four-joint link.

In the vehicular sliding door opening and closing apparatus, the door brackets may be installed on upper and lower portions of the sliding door.

The vehicular sliding door opening and closing apparatus may further include a driver motor installed on the vehicle, a screw rotatably installed on the vehicle in such a manner as to be arranged along the lengthwise direction of the vehicle, the screw being rotated by the drive motor, and a moving block coupled to the screw in a nut-bolt fastening manner, the moving block being moved along an axial direction of the screw and being fastened to the carrier when the screw is screwed, wherein, when the drive motor is rotated, the carrier may be moved along the lengthwise direction of the vehicle.

In the vehicular sliding door opening and closing apparatus according to embodiments of the present invention, which has the configurations described above, the upper and lower portion of the sliding door are each slid in supported states thereof. Thus, although the center rail is not used, the sliding door stably operates.

Since the center rail is not used, a decrease in the exterior appearance quality of the vehicle due to the installation of the center rail on the lateral side of the vehicle can be prevented.

Moreover, a space wherein the sliding door operates for opening and closing is minimized inside the vehicular body. Thus, an internal space and a space for mounting a battery can be further expanded.

### BRIEF DESCRIPTION OF THE DRAWINGS

FIG. 1 is a side view illustrating a closed state of a sliding door of a vehicle in which a vehicular sliding door opening and closing apparatus according to embodiments of the present disclosure is used.

FIG. 2 is a side view illustrating an open state of the sliding door of the vehicle in which the vehicular sliding door opening and closing apparatus according to embodiments of the present disclosure is used.

FIG. 3 is a perspective view illustrating the sliding door in which the vehicular sliding door opening and closing apparatus according to embodiments of the present disclosure is used.

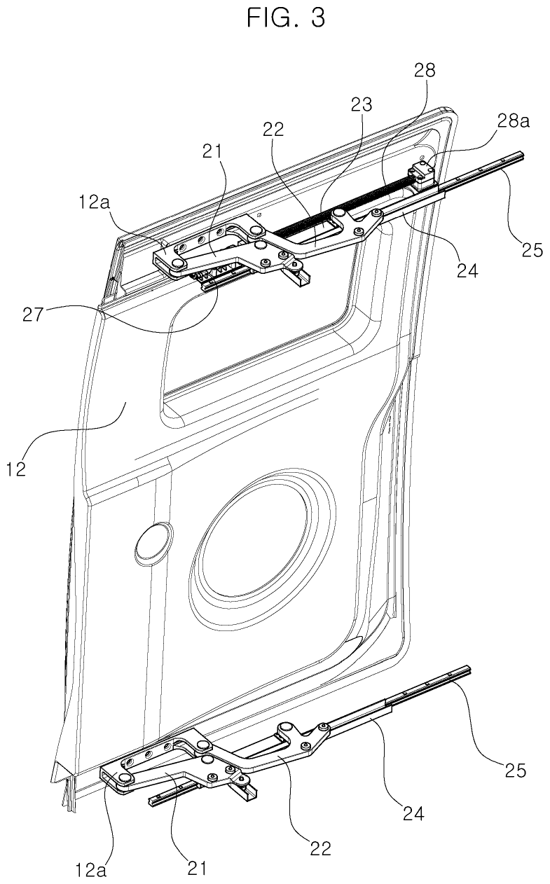

FIG. 4 is a perspective view illustrating the vehicular sliding door opening and closing apparatus according to embodiments of the present disclosure.

FIG. 5 is an exploded perspective view illustrating the vehicular sliding door opening and closing apparatus according to embodiments of the present disclosure.

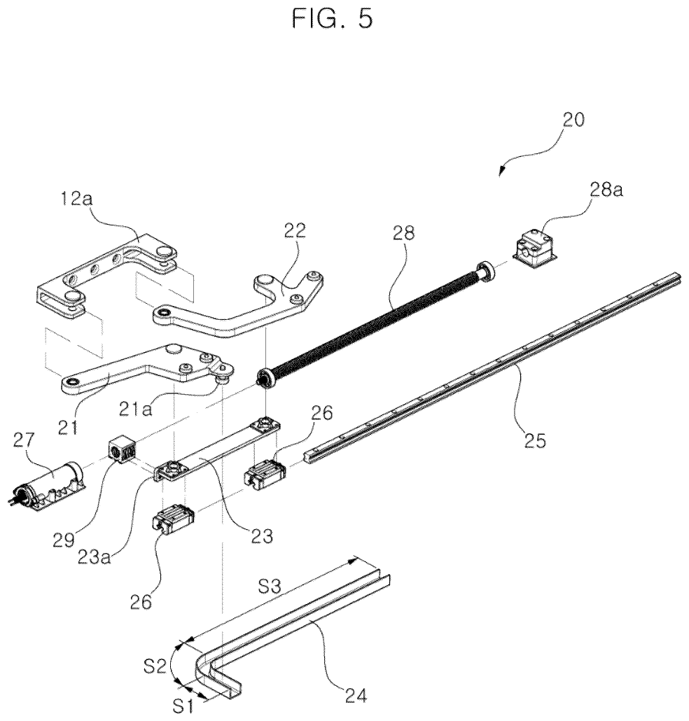

FIG. 6 is a top view illustrating the vehicular sliding door opening and closing apparatus according to embodiments of the present disclosure in the state where the sliding door is closed.

FIG. 7 is a top view illustrating the vehicular sliding door opening and closing apparatus according to embodiments of the present disclosure in an initial popped-out state of the sliding door.

FIG. 8 is a top view illustrating the vehicular sliding door opening and closing apparatus according to embodiments of the present disclosure in a final popped-out state of the sliding door.

FIG. 9 is a top view illustrating the vehicular sliding door opening and closing apparatus according to embodiments of the present disclosure in the open state of the sliding door.

### DETAILED DESCRIPTION OF ILLUSTRATIVE EMBODIMENTS

A vehicular sliding door opening and closing apparatus 20 according to embodiments of the present disclosure will be described below with reference to the accompanying drawings.

The vehicular sliding door opening and closing apparatus 20 according to embodiments of the present disclosure may include a carrier 23 slidably installed along a lengthwise direction of a vehicle 1, a pair of links 21 and 22 rotatably installed on the carrier 23 to be spaced apart from each other, one end portion of the pair of links 21 and 22 being hinge-connected to a sliding door 12 of the vehicle 1, and a popping-out unit for popping the sliding door 12 out of a vehicular body 11 of the vehicle 1 by rotating the pair of links 21 and 22 during an initial stage of opening of the sliding door 12.

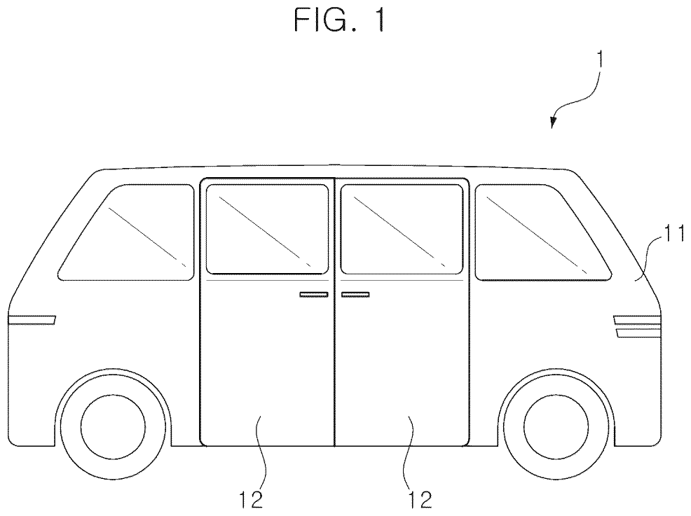

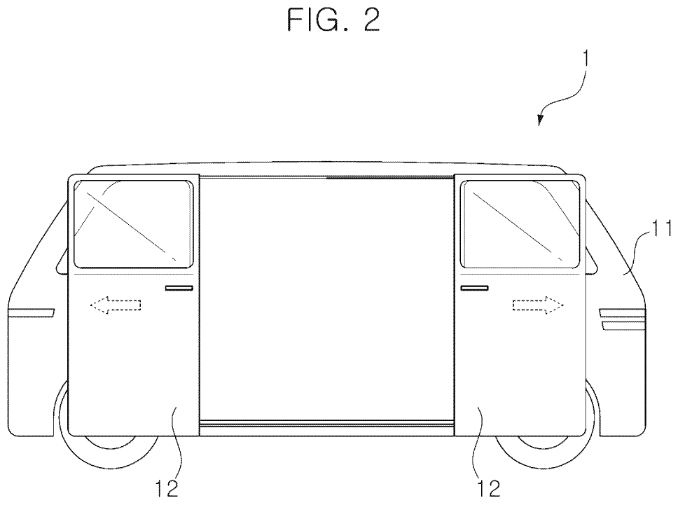

The vehicle 1 in which the vehicular sliding door opening and closing apparatus 20 according to embodiments of the present disclosure is used is illustrated in FIGS. 1 and 2.

The sliding door 12 may be installed on a lateral side of the vehicular body 11 of the vehicle 1 along the lengthwise direction of the vehicle 1. The sliding door 12 may be open when an occupant enters and exits a compartment of the vehicle 1 or when luggage is loaded into and unloaded from the vehicle 1.

The vehicle 1 here may include a purpose-built vehicle (PBV). In most cases, the PBV may be realized as an electric vehicle. In order to utilize the internal space or for other purposes, the vehicle 1, which is the PBV, may be configured in such a manner that the lateral side of the vehicle 1 is to be opened as wide as possible. For this reason, the sliding doors 12 may be installed on the lateral side of the vehicular body 11 in such a manner as to be opened and closed in opposite directions.

The vehicular sliding door opening and closing apparatus 20 according to embodiments of the present disclosure may be installed in an internal surface of the sliding door 12 in such a manner that the sliding door 12 is opened and closed along the lateral side of the vehicle 1.

The carrier 23 may be installed on the vehicular body 11 in a manner that is slidable along the lengthwise direction of the vehicle 1. The carrier 23 may be required to slide along the lengthwise direction of the vehicle 1. For this reason, the carrier 23 may be installed through a guide rail 25 and a slider 26 instead of being directly installed on the vehicular body 11.

The guide rail 25 may be fixedly installed along the lengthwise direction of the vehicular body 11. The slider 26 may be slidably installed on the guide rail 25. The carrier 23 may be mounted on the slider 26.

It is preferred that an LM guide is employed as the guide rail 25. Accordingly, a friction may be reduced when opening and closing the sliding door 12, and thus the sliding door 12 may also be slid with less force.

The carrier 23 may be assembled to the slider 26 at a plurality of points thereon. Thus, the carrier 23 may be stably slid.

A plurality of the links 21 and 22 may connect the carrier 23 and the sliding door 12 to each other. The links 21 and 22 may enable the sliding door 12 to be popped out during the initial state of opening of the sliding door 12, taking up less space, and to maintain a popped-out state thereof during a sliding operation. Accordingly, a space necessary for an occupant to enter and exit the vehicle 1 and a space in which a battery is mounted may be further expanded.

A door bracket 12a may be installed on the internal surface of the sliding door 12 in such a manner that the links 21 and 22 are connected to the sliding door 12.

The links 21 and 22 may be provided as a pair, with one as a first link 21 and the other as a second link 22. The first link 21 and the second link 22, which are spaced apart from each other, may be hinge-connected to the carrier 23 and the door bracket 12a. That is, a middle portion of the first link 21 may be hinge-connected to the carrier 23 in a manner that is rotatable about a first link rotational axis L1, and one end portion thereof may be connected to the door bracket 12a with a first link door bracket rotational axis B1 as a hinge axis. The second link 22 may be also connected to the carrier 23 in a manner that is rotatable about a second link rotational axis L2, and one end portion thereof may be hinge-connected to the door bracket 12a with a second link door bracket rotational axis B2 as a hinge axis.

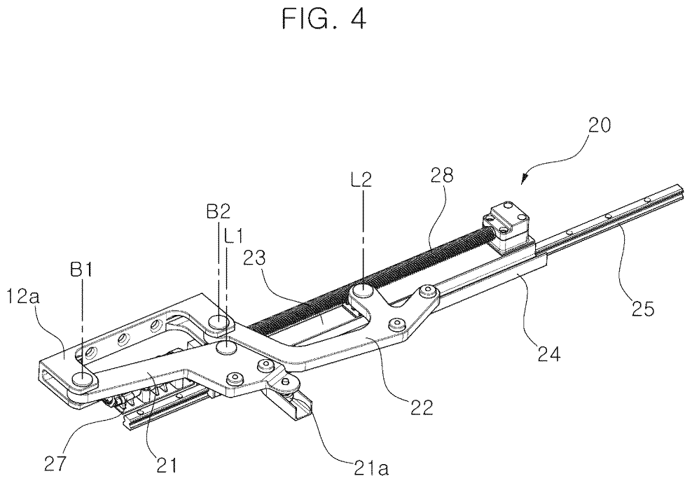

A length between a portion of the carrier 23 to which the first link 21 is hinge-connected and a portion thereof to which the second link 22 is hinge-connected may be the same as a length between a portion of the door bracket 12a to which the first link 21 is hinge-connected and a portion thereof to which the second link 22 is hinge-connected. That is, in FIG. 4, a length between the first link rotational axis L1 and the second link rotational axis L2 may be the same as a length between the first link door bracket rotational axis B1 and the second link door bracket rotational axis B2. In addition, the first link 21 and the second link 22 may be formed in such a manner as to have equal lengths from their respective rotational centers where they are hinge-connected to the carrier 23 and to their respective other ends where they are hinge-connected to the door brackets 12a. That is, in FIG. 4, a length between the first link rotational axis L1 and the first link door bracket rotational axis B1 may be the same as a length between the second link rotational axis L2 and the second link door bracket rotational axis B2.

The carrier 23, the first link 21, the second link 22, and the door bracket 12a may form a parallelogramic four-joint link. Accordingly, the sliding door 12 may be popped over a predetermined distance from the lateral side of the vehicular body 11. Then, the sliding door 12 may be slid along a lengthwise direction of the vehicle 1 in the popped-out state thereof.

In a closed state, the sliding door 12 may be positioned in the same line as the lateral side of the vehicle 1. However, the sliding door 12 may be required to be spaced a predetermined distance apart from the outer surface of the vehicular body 11 while being slid for opening and closing. To this end, the popping-out unit may be provided. The popping-out unit may pop the sliding door 12 out of the vehicular body 11 by rotating the first link 21 and the second link 22 during the initial stage of an opening operation of the sliding door 12. In addition, the popping-out unit may rotate the first link 21 and the second link 22, in the opposite direction to a direction of rotating the first link 21 and the second link 22 when opening the sliding door 12, during a last stage of a closing operation of the sliding door 12, and thus may enable the sliding door 12 to be positioned in the same line as the vehicular body 11.

To this end, the popping-out unit may include a roller 21a that is installed on the other end portion of the first link 21 and a moving guide 24 guiding a tracking path for the roller 21a.

The roller 21a may be rotatably installed on the other end portion of the first link 21.

The moving guide 24 may accommodate the roller 21a inside thereof. The other end portion of the first link 21, moving together with the carrier 23, may move the moving guide 24, thereby rotating the first link 21. The first link 21 may be rotated in this manner, and thus the sliding door 12 may operate to be popped out of the vehicular body 11 or to retract thereinto.

The moving guide 24 may be formed to have a concave cross section, and thus the roller 21a may be positioned inside the moving guide 24.

During the initial stage of the opening operation of the sliding door 12, the moving guide 24 may rotate the first link 21 to pop out the sliding door 12, during the initial stage of the opening operation of the sliding door 12, or may block the first link 21 from being rotated, while the sliding door is slid for opening and closing. The moving guide 24 may have a profile including a first popping-out section S1, a second popping-out section S2, and a sliding section S3, for guiding the sliding door 12 to be slid after being popped out. That is, the first popping-out section S1 of the moving guide 24 may be formed in a widthwise direction of the vehicle 1, the sliding section S3 may be formed in the lengthwise direction of the vehicle 1, and the second popping-out section S2 may be formed in a circular arc shape and connect an external end of the first popping-out section S1 and one end of the sliding section S3. When the roller 21a stays in the first popping-out section S1 and the second popping-out section S2, the first link rotational axis L1 of the first link 21 and the roller 21a may vary in their relative positions, and accordingly, the first link 21 may be rotated.

While the carrier 23 is slid along the lengthwise direction of the vehicle 1, the roller 21a may be moved in the first popping-out section S1. As a result, the first link 21 may be also rotated, thereby partially popping out the sliding door 12 in a closed state thereof.

Thereafter, the carrier 23 may be moved in the second popping-out section S2 while being continuously slid. As a result, the first link 21 may be rotated, thereby fully popping out the sliding door 12. An amount of rotation of the first link 21 may be greater when the roller 21a is moved in the first popping-out section S1 than when the roller 21a is moved in the second popping-out section S2. As a result, a distance over which the sliding door 12 is popped out also may be greater.

When the sliding door 12 is fully popped out and thus the roller 21a is moved in the sliding section S3, the first link rotational axis L1 of the first link 21 and the roller 21a may not vary in their respective relative positions. As a result, the first link 21 may not be rotated. Accordingly, the second link 22 and the door bracket 12a may not be relatively rotated. As a result, the sliding door 12 may maintain the popped-out state thereof. In this state, the carrier 23 may be moved, and thus the sliding door 12 may be slid for opening and closing.

The second link 22, together with the first link 21, the carrier 23, and the door bracket 12a, may form the parallelogramic four joint link. As a result, the second link 22, like the first link 21, may be moved. Therefore, when the roller 21a is installed on the first link 21 and the roller 21a is moved on the moving guide 24, the roller 21a and the moving guide 24 may not have an influence on the operation of the second link 22.

Moreover, the roller 21a and the moving guide 24 may be installed in the direction of the second link 22 instead of the first link 21.

A drive motor 27, which outputs a rotational force when powered, may be mounted in such a manner that the sliding door 12 is automatically closed and opened, and thus the carrier 23 may be moved.

The drive motor 27 may be installed on one side of the vehicular body 11, and, when powered, may output the rotational force. The drive motor 27 may be rotated in opposite directions when the sliding door 12 is opened and closed.

A screw 28 may be rotatably installed on the vehicle 1 in such a manner as to be arranged along the lengthwise direction of the vehicle 1. The screw 28 may be rotated by the drive motor 27. One end portion of the screw 28 may be connected to the drive motor 27, and the other end thereof may be supported on a screw mount 28a installed on the vehicular body 11.

A moving block 29 may be coupled to the screw 28 in a nut-bolt fastening manner. The moving block 29 may be fastened to the carrier 23. The moving block 29 and the carrier 23 may be fastened to each other using a fastening unit 23a formed on one side of the carrier 23 in a bent manner.

The coupling of the screw 28 and the moving block 29 may enable a rotational movement of the screw 28 into a straight-line movement of the moving block 29. The straight-line movement of the moving block 29 may move the carrier 23 in the lengthwise direction of the vehicle 1, thereby sliding the sliding door 12 in the lengthwise direction of the vehicle 1.

When the drive motor 27, the screw 28, and the moving block 29 may not be mounted, the sliding door 12 may be mounted open and closed.

The vehicular sliding door opening and closing apparatuses 20, configured as described, may be installed on upper and lower portions, respectively, of the sliding door 12, and thus may open and close the sliding door 12 by guiding the upper and lower portions of the sliding door 12, respectively. The door brackets 12a may be installed on the upper and lower portions, respectively, of the sliding door 12. With the door bracket 12a, the vehicular sliding door opening and closing apparatuses 20 may be connected to the sliding door 12.

However, the drive motor 27, the screw 28, and the moving block 29 may be installed on one of the upper and lower portions of the sliding door 12, preferably, on the upper portion of the sliding door 12. Accordingly, when the upper portion of the sliding door 12 operates, the lower portion thereof may operate along the same tracking path as the upper portion. Consequently, the sliding door 12 may be opened and closed.

Moreover, as illustrated in FIGS. 1 and 2, in a case where a pair of the sliding doors 12 is installed on one lateral side of the vehicle 1, the vehicular sliding door opening and closing apparatuses 20, as described above, may be configured to be symmetrical with respect to each other and thus may be used in the sliding doors 12, respectively.

Operation of the vehicular sliding door opening and closing apparatus 20 according to embodiments of the present disclosure, which has the configuration as described above, is described as follows.

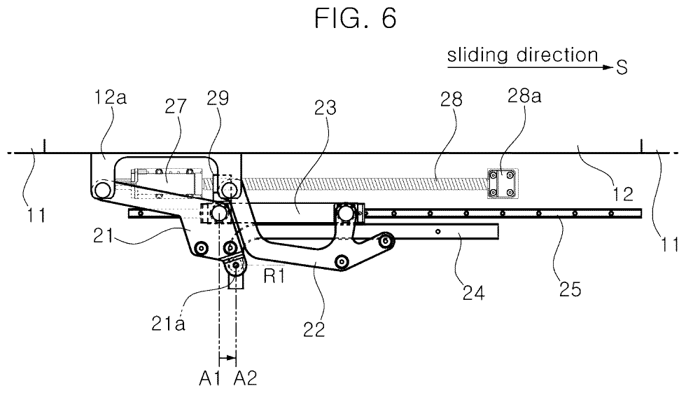

FIG. 6 illustrates a state where the sliding door 12 is closed. The sliding door 12 and the vehicular body 11 may be disposed on the same line in the state where the sliding door 12 is closed.

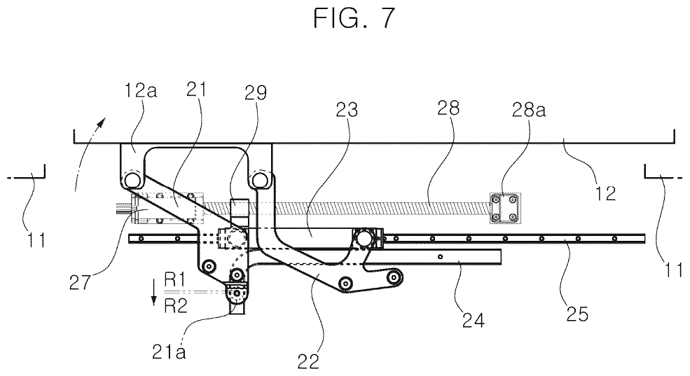

FIG. 7 illustrates an initial popped-out state of the sliding door 12.

When the occupant operates a switch installed on the vehicle 1 to open the sliding door 12, the drive motor 27 may be rotated, thereby rotating the screw 28.

When the screw 28 moves the moving block 29 along a lengthwise direction of the screw 28, the carrier 23, together with the moving block 29, also may be moved along the guide rail 25.

When the carrier 23 starts to be moved along the lengthwise direction of the vehicle 1, with the movement of the carrier 23, the first link 21 and the second link 22 also may be moved together with the carrier 23.

At this point, the roller 21a may be moved inside the moving guide 24. As a result, the first link 21 may be rotated. The first link rotational axis L1 of the first link 21 may be moved along the moving block 29 along the lengthwise direction of the vehicle 1, and the roller 21a may be moved inside the moving guide 24. As a result, the first link 21 may be rotated about the first link rotational axis L1. At this point, the first link 21 may be rotated in a direction of moving the sliding door 12 away from the vehicular body 11. The first link 21, the door bracket 12a, the second link 22, and the carrier 23 may form the parallelogramic four joint link. As a result, when the first link 21 is rotated about the carrier 23, the second link 22 also may be rotated in the same direction as the first link 21. Consequently, the door bracket 12a may be spaced apart from the carrier 23. Accordingly, the sliding door 12 may be popped out of the vehicular body 11.

From a closed state of the sliding door 12 to an initial open state thereof, the roller 21a may be moved over a short distance toward the inside of the vehicle 1 in the first popping-out section S1 of the moving guide 24. That is, with reference to FIG. 6, the roller 21a may be positioned more toward the front, in the sliding direction, of the sliding door 12 than the first link rotational axis L1 of the first link 21 (Line A2 is positioned more rightward than Line A1). Thereafter, when the first link 21 is rotated while being moved along the carrier 23, as illustrated in FIG. 7, the first link rotational axis L1 of the first link 21 may lie on the same line as the roller 21a, and the center of the roller 21a may be moved over a short distance toward the inside of the vehicle 1 from Point R1 to Point R2. Accordingly, this movement may limit excessive protrusion, in the widthwise direction of the vehicle 1, of the sliding door 12.

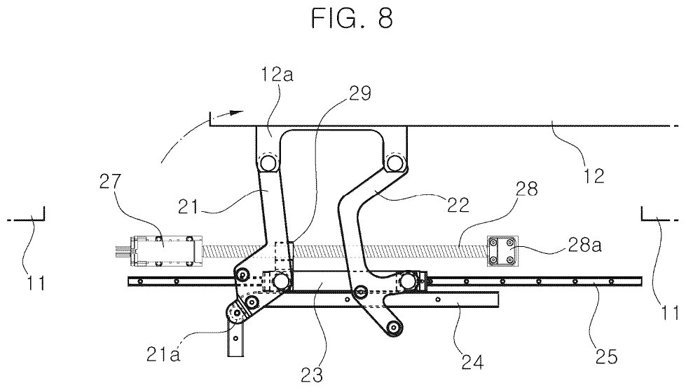

FIG. 8 illustrates a last popped-out state of the sliding door 12.

When the drive motor 27 is continuously rotated, the carrier 23 may be moved along the guide rail 25 along the lengthwise direction of the vehicle 1. As a result, the first link 21 and the second link 22 also may be continuously moved.

At this point, the first link 21 still may be moved to the second popping-out section S2 of the moving guide 24. As a result, the first link 21 may pop the sliding door 12 out of the vehicle 1 while being rotated about the first link rotational axis L1.

When the roller 21a is moved in the first popping-out section S1 and the second popping-out section S2 of the moving guide 24, the sliding door 12 also may be popped out in the widthwise direction of the vehicle 1 while being slid along the lengthwise direction of the vehicle 1.

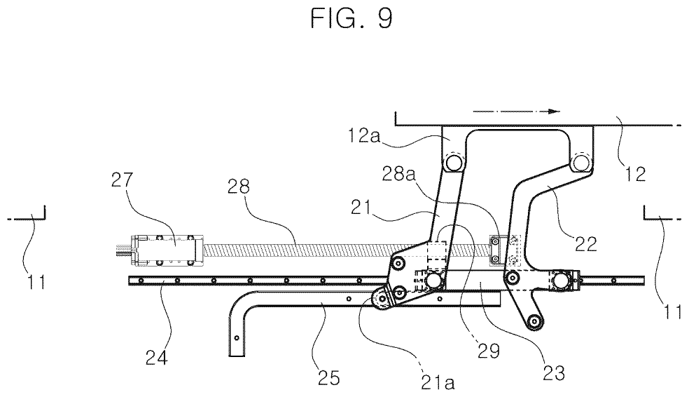

FIG. 9 illustrates a state where the sliding door 12 is slid after being fully popped out.

With the rotation of the drive motor 27, the carrier 23 may be continuously moved along the guide rail 25. Thereafter, the first link 21 and the second link 22 also may be moved along the lengthwise direction of the vehicle 1.

The roller 21a may be moved along the sliding section S3 of the moving guide 24. As a result, the first link 21 and the second link 22, together with the carrier 23, may be moved along the lengthwise direction of the vehicle 1, without being further rotated. Thus, the sliding door 12 may be fully opened at the lateral side of the vehicle 1.

When the sliding door 12 is moved a predetermined distance, the sliding door 12 may be stopped, thereby maintaining an open state thereof. For example, a striker (not illustrated) installed on the sliding door 12 may be hooked onto a latch (not illustrated) installed on the vehicular body 11, and thus fixed thereto. As a result, the open state of the sliding door 12 may be maintained.

To close the sliding door 12, the operations described above to open the sliding door 12 may be performed in a reverse order. Accordingly, the sliding door 12 may be closed.

When the drive motor 27 is rotated in the opposite direction, the other constituent elements may operate contrary to the opening direction of the sliding door 12. As a result, the sliding door 12 may be closed.

1. An opening and closing apparatus of a sliding door of a vehicle, the apparatus comprising:
a carrier slidably installed along a lengthwise direction of the vehicle;
a pair of links rotatably installed on the carrier and spaced apart from each other, wherein a first end portion of the pair of links is hingedly-connected to the sliding door of the vehicle; and
a popping-out device that includes a roller installed on a second end portion of the pair of links, the popping-out device configured to pop the sliding door out of a vehicle body of the vehicle by rotating the pair of links during an initial stage of an opening operation of the sliding door;
wherein the apparatus is configured so that, in a state in which the sliding door is closed, the roller is positioned more toward a front of the sliding door, in a sliding direction of the sliding door, than a first link rotational axis of the first link, such that a center of the roller moves over a short distance toward an inside of the vehicle to limit excessive protrusion of the sliding door in a widthwise direction of the vehicle.

2. The apparatus of claim 1, wherein the popping-out device further comprises a moving guide configured to rotate the pair of links during the initial stage of the opening operation of the sliding door by guiding a tracking path for the roller.

3. The apparatus of claim 2, wherein the moving guide comprises:
a first popping-out section disposed along the widthwise direction of the vehicle;
a sliding section disposed along the lengthwise direction of the vehicle; and
a second popping-out section disposed in a circular arc shape and connecting an external end of the first popping-out section and one end of the sliding section.

4. The apparatus of claim 3, wherein, in a state in which the pair of links is moved along the carrier, the roller is configured to rotate the pair of links while being moved in the first popping-out section and the second popping-out section, thereby popping out the sliding door.

5. The apparatus of claim 3, wherein the pair of links is rotated more when the roller is moved in the first popping-out section than when the roller is moved in the second popping-out section.

6. The apparatus of claim 3, wherein, in a state in which the roller is moved in the sliding section, the pair of links is not further rotated such that the sliding door maintains a popped-out state.

7. The apparatus of claim 2, wherein:
the pair of links comprises a first link and a second link spaced apart from each other along the lengthwise direction of the vehicle; and
the roller is installed on the second end portion of the first link.

8. (canceled)

9. The apparatus of claim 2, wherein the moving guide has a concave cross section, and the roller is configured to be positioned and moved inside the moving guide.

10. The apparatus of claim 1, further comprising:
a guide rail installed on the vehicle body along the lengthwise direction of the vehicle; and
a slider slidably installed on the guide rail, the carrier being mounted on the slider.

11. The apparatus of claim 10, wherein the slider is one of a plurality of sliders mounted on the carrier, the sliders being spaced apart from each other.

12. An opening and closing apparatus of a sliding door of a vehicle, the apparatus comprising:
a carrier slidably installed along a lengthwise direction of the vehicle;
a pair of links rotatably installed on the carrier and spaced apart from each other;
a popping-out device including a roller installed on a second end portion of the pair of links and configured to pop the sliding door out of a vehicle body of the vehicle by rotating the pair of links during an initial stage of an opening operation of the sliding door; and
a door bracket installed on the sliding door, wherein a first end portion of each of the pair of links is hingedly-connected to the door bracket;
wherein the apparatus is configured so that, in a state in which the sliding door is closed, the roller is positioned more toward a front of the sliding door, in a sliding direction of the sliding door, than a first link rotational axis of the first link, such that a center of the roller moves over a short distance toward an inside of the vehicle to limit excessive protrusion of the sliding door in a widthwise direction of the vehicle.

13. The apparatus of claim 12, wherein the carrier, the pair of links, and the door bracket define a parallelogramic four-joint link.

14. The apparatus of claim 13, wherein the door bracket is one of a plurality of door brackets, the door brackets being installed on upper and lower portions of the sliding door, respectively.

15. An opening and closing apparatus of a sliding door of a vehicle, the apparatus comprising:
a slider slidably installed along a lengthwise direction of the vehicle;
a carrier mounted on the slider;
a pair of links rotatably installed on the carrier and spaced apart from each other, wherein a first end portion of the pair of links is hingedly connected to the sliding door of the vehicle;
a drive motor configured to output a rotational force to move the carrier in the lengthwise direction of the vehicle to open and close the sliding door; and
a popping-out device including a roller installed on a second end portion of the pair of links and configured to pop the sliding door out of a vehicle body of the vehicle by rotating the pair of links during an initial stage of an opening operation of the sliding door,
wherein the apparatus is configured so that, in a state in which the sliding door is closed, the roller is positioned more toward a front of the sliding door, in a sliding direction of the sliding door, than a first link rotational axis of the first link, such that a center of the roller moves over a short distance toward an inside of the vehicle to limit excessive protrusion of the sliding door in a widthwise direction of the vehicle.

16. The apparatus of claim 15, further comprising:
a screw rotatably installed on the vehicle and arranged along the lengthwise direction of the vehicle, wherein the screw is rotatable by the drive motor; and
a moving block coupled to the screw, along an axial direction of the screw, and fastened to the carrier.

17. The apparatus of claim 16, wherein the popping-out device comprises a moving guide configured to rotate the pair of links during the initial stage of the opening operation of the sliding door by guiding a tracking path for the roller.

18. The apparatus of claim 17, wherein the moving guide comprises:
a first popping-out section disposed in the widthwise direction of the vehicle;
a sliding section disposed in the lengthwise direction of the vehicle; and
a second popping-out section disposed in a circular arc shape and connecting an external end of the first popping-out section and one end of the sliding section.

19. The apparatus of claim 18, wherein:
the pair of links comprises a first link and a second link arranged to be spaced apart from each other along the lengthwise direction of the vehicle; and
the roller is installed on the second end portion of the first link.

20. The apparatus of claim 19, further comprising a door bracket installed on the sliding door, wherein the first end portion of each of the pair of links is hingedly-connected to the door bracket, and wherein the carrier, the pair of links, and the door bracket define a parallelogramic four-joint link.

21. The apparatus of claim 1, further comprising a guide rail installed on the vehicle body along the lengthwise direction of the vehicle.
